(19) United States
(12) Patent Application Publication
(10) Pub. No.: US 2015/0084767 A1
(43) Pub. Date: Mar. 26, 2015

(54) DETECTOR WITH INTEGRATED SENSOR PLATFORM

(71) Applicant: Life Safety Distribution AG, Morristown, NJ (US)

(72) Inventors: Tak G. Saruwatari, Calgary (CA); Mahdi Javer, Calgary (CA); Kelly A.F. Englot, Calgary (CA); Richard Ian King, Ferndown (GB)

(73) Assignee: Life Safety Distribution AG, Morristown, NJ (US)

(21) Appl. No.: 14/197,531

(22) Filed: Mar. 5, 2014

Related U.S. Application Data
(60) Provisional application No. 61/880,434, filed on Sep. 20, 2013.

(51) Int. Cl. G08B 19/00

(52) U.S. Cl. CPC G08B 19/00
USPC 340/521

(57) ABSTRACT

An integrated system platform includes a sensor containing an embedded microcontroller and associated circuitry for providing safety critical functionality. Signal conditioning circuitry is coupled to the sensor along with gas concentration determining circuitry, alarm status circuitry and fault status evaluation circuitry. Wherein the sensor is operational with a main control module and at least one alarm output device.

### CROSS-REFERENCE TO RELATED APPLICATION

This application claims the benefit of the filing date of U.S. Provisional Application Ser. No. 61/880,434 filed Sep. 20, 2013, entitled, “Integrated Sensor Platform”. The '434 application is hereby incorporated herein by reference.

### FIELD

The application pertains to gas or smoke detectors. More particularly, the application pertains to portable detectors which include standardized sensing modules which have been certified by an agency, and, are usable with different peripheral circuits without loss of that certification.

### BACKGROUND

Portable gas detectors are being subjected to ever more rigorous regulatory performance certifications. Some of these performance approvals now include a software evaluation. This evaluation typically means that all software in the detector is evaluated and then controlled by an agency from that point forward. This level of control makes it very difficult to make changes or add features to existing designs.

Such regulatory involvement can increase the time needed to commercialize and market new detectors and features, which in turn can lead to a competitive disadvantage in the marketplace. In addition to software certifications, detectors are also usually subject to regulatory evaluations of the hardware that is used to implement gas sensing circuitry. Thus, even if a sensor has been previously certified to a particular performance standard, each new instrument use requires recertification. This process can result in further increased delays with regard to the launch cycle of new products.

### BRIEF DESCRIPTION OF THE DRAWINGS

FIG. 1 illustrates a block diagram of a system in accordance herewith.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

It will be recognized by persons of ordinary skill in the art that embodiments hereof provide a new platform that can reduce the development time by eliminating much of the evaluation performed by regulatory agencies. Generally, embodiments disclosed herein are able to satisfy this objective by providing a novel sensor and method that can determine alarm conditions of a particular gas channel. This process can generally involve calculating a final gas reading; determining high and low alarms; determining fault conditions for the sensor, and providing an alarm indication.

Such embodiments are able to carrying out this process without intervention from the main controller and thus can be considered as a separate safety critical subsystem. This process can enable the safety critical functionality to be contained within a sensor module such that a main processor of a respective detector, responsible for driving the output display device, for example a liquid crystal display device (LCD), as well as any other value added functions, does not need to be evaluated to the same level as the safety critical portion.

Thus, a self-contained sensing element as described herein can become a platform around which instrument families, which can include various types of detectors, can be designed. It will be recognized that this configuration can save anywhere from six months to a year on each new development cycle and can also enable incremental changes and updates to be made to the subject detectors without each change requiring an update to the performance evaluation. Such benefits are at least in part due to the fact that embodiments hereof can be partitioned into safety/non-safety blocks, or modules, which can provide flexibility and simplification of the agency requirements for value added features. These embodiments can provide important advantages in the market by enabling users to respond more quickly to customer requests and expectations.

The Integrated Sensor Platform described herein can be implemented by embedding a programmable processor, such as a micro controller, into the sensor. This controller can perform a series of functions, including converting an analog signal from the sensor to final measurement units, comparing this measured value to stored alarm setpoints, determining fault conditions for the sensor, determining high/low alarm conditions, driving high and low alarms with dedicated output pins, providing a fault status signal via a dedicated output pin, communicating sensor readings to the main controller for display on the LCD, and incorporating the necessary hardware to perform self-diagnostics and prevent runaway conditions.

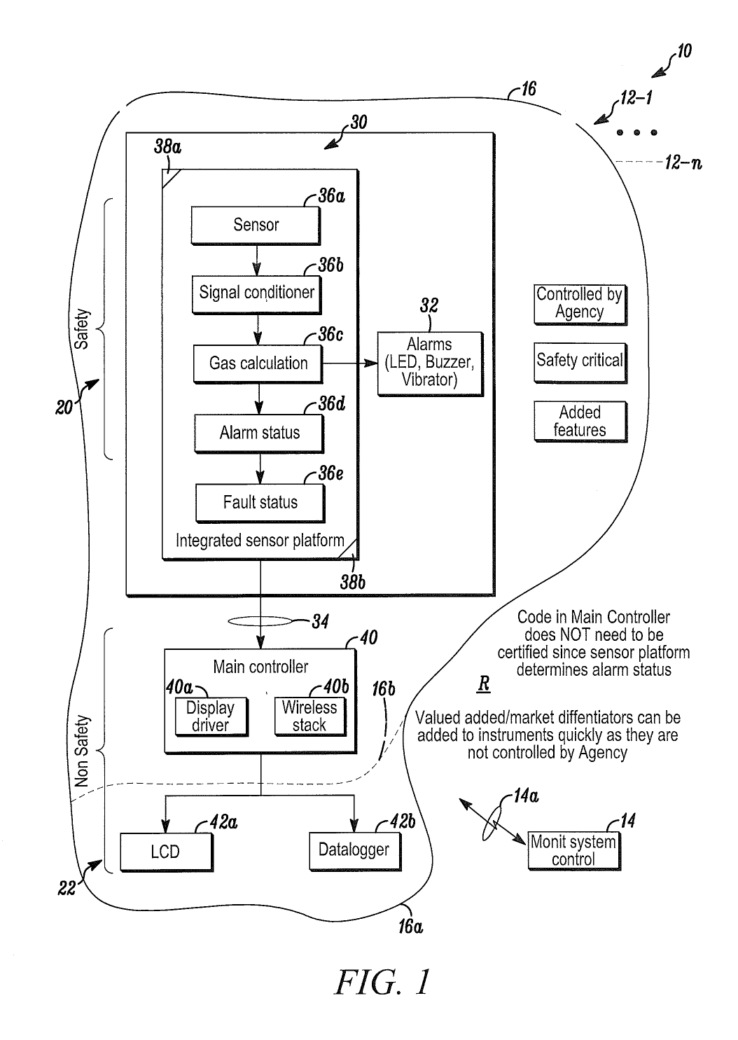

FIG. 1 illustrates a system 10 in accordance herewith. As those of skill will understand, system 10 functions to monitor one or more ambient conditions in region R. For example, system 10 might include a plurality of detectors 12, as discussed below, scattered throughout the region R. As described, the detectors 12-i advantageously separate circuitry which carries out functions related to safety, and must be certified by an appropriate Agency, from non-safety related circuits which do not need certification and are not subject to Agency control.

The detectors 12-i can communicate via a wired or wireless medium 14a with a monitoring system control unit 14.

Detector 12-1 is representative of the members of the plurality of detectors 12. Hence, a discussion of detector 12-1 will apply to remaining members of the plurality 12.

As illustrated in FIG. 1, a housing 16 carries various elements of detector 12-1. As explained below, housing 16 can readily be designed to carry more or less circuitry, hence functionality, without a need for additional certifications. Other housing configurations come within the spirit and scope hereof.

Circuitry in housing 16 is partitioned into safety related components, or module, 20 and non-safety related circuitry, or module, 22. For example, safety related module 20 includes all agency controlled safety critical elements. These can be implemented as an integrated sensor platform 30 and an associated alarm indicator 32. Platform 30 and output device(s) 32 are interconnected, and platform 30 can provide outputs, 34 to non-safety elements 22.

A single housing is not required. Separate housings for each module type, 20, 22 can be provided. Both modules can be carried on a single substrate.

Platform 30 can include one or more sensor(s) 36a, which can include gas sensors, fire or smoke sensors, radiation sensors all without limitation. Signal conditioning circuitry 36b, gas or smoke level determination circuitry 36c, alarm status indicating circuitry 36d, and fault status indicting circuitry 36e. Circuits 36 can be implemented at least in part with a programmable processor, microcontroller 38a, and associated executable instructions 38b. Those of skill will understand that the instructions 38b can be installed in read only memory, read-write memory or any other configuration without departing from the spirit and scope hereof. Processor 38a, with instructions 38b can also drive the alarm indicating output devices such as light emitting diodes, buzzers or vibrators 32.

Since the sensor platform 30 determines alarm status, the non-safety module 22 does not need agency certification. As a result, users can readily specify or install variations on the circuitry therein.

Without limitation, the non-safety module 22 can include a programmable controller 40 which includes one or more display drivers 40a, and wireless communications circuitry 40b. The controller 40 can also be coupled to liquid crystal display 42a, and datalogger 42b. Advantageously, and, in accordance herewith, users can request versions of detector 12-1 that include the display 42a and datalogger 42b in the housing 16, or in a second, separate housing 16a, as indicted by housing dashed wall 16b. In either instance, the certified safety module 20 is not revised or altered, and no recertification will be required.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. A detector comprising:
a sensor module which includes a sensor, circuitry which provides at least one of gas, fire, smoke or radiation sensing evaluation of potential alarm conditions in response to outputs from the sensor, and, generation of at least one output indicator in response thereto in accordance with predetermined certification requirements; and
a second module which is coupled to the sensor module and which provides different, uncertified functions.

2. A detector as in claim 1 where the sensor module includes at least one of a gas sensor, a smoke sensor, a fire sensor, or a radiation sensor.

3. A detector as in claim 2 wherein alarm evaluations are implemented by a programmable processor and executable control instructions carried in the first part.

4. A detector as in claim 3 where the processor and instructions provide output signals to drive local output devices.

5. A detector as in claim 3 where the processor and instructions process signals from the at least one sensor to compare a representation of those signals to a predetermined indicator of an alarm condition and production of an electrical signal indicative thereof.

6. A detector as in claim 2 wherein the sensor module is carried by the second module.

7. A detector as in claim 1 wherein the modules are carried by a common support member.

8. A detector as in claim 5 wherein the sensor module is carried by the second module.

9. A detector as in claim 8 wherein additional functions can be implemented in the second module without altering certification of the sensor module.

10. A modular detector comprising:
a sensing module with at least one ambient condition sensor, and condition sensing and evaluating circuitry coupled thereto wherein the circuitry includes executable control instructions wherein the configuration and performance of the instructions pertains to regulated, safety issues; and
an electronic module coupled to the sensing module which includes circuits that do not pertain to regulated safety issues.

11. A detector as in claim 10 where the evaluating circuitry evaluates signals from the sensor to determine the presence of an alarm condition.

12. A detector as in claim 11 where indicia of a detected alarm condition are coupled to the electronic module for transmittal to a displaced location.

13. A detector as in claim 12 wherein the electronic module is separately modifiable independently of the sensing portion without altering a certification status of the sensing module.

14. A detector as in claim 13 wherein the electronic module includes at least one of a display driver as well as communications circuitry.

15. A detector as in claim 10 where the sensor is selected from a class which includes at least one of a gas sensor, a smoke sensor, a fire sensor, and a radiation sensor.

16. An integrated system platform comprising:
a sensor module containing an embedded microcontroller and associated circuitry for providing safety critical functionality, and including signal conditioner circuitry, coupled to the sensor, concentration determining circuitry, alarm status circuitry and fault status evaluation circuitry and wherein the sensor module is coupled to a main control module and at least one alarm output device.

17. An integrated system platform as in claim 16 where the sensor module includes a sensor selected from a class which includes at least one of a gas sensor, a smoke sensor, a fire sensor, and a radiation sensor.

18. An integrated system platform as in claim 16 where the main control module is separately modifiable independently of the sensor module without altering a certification status of the sensor module.
